(19) United States
(12) Patent Application Publication
(10) Pub. No.: US 2003/0016183 A1
(43) Pub. Date: Jan. 23, 2003

(54) Adjustable support column

(76) Inventors: Charles Walter Pyanowski, Summerville, SC (US); Daniel Brian Martin, Goose Creek, SC (US); Joseph John Nemeth III, Charleston, SC (US)

Correspondence Address: John B. Hardaway, III, Nexsen Pruet Jacobs & Pollard, LLC, 201 West McBee Avenue, Suite 400, Post Office Drawer 10648, Greenville, SC, 29603, US

(21) Appl. No.: 10/200,866

(22) Filed: Jul. 23, 2002

Related U.S. Application Data
(63) Continuation-in-part of application No. 09/908,094, filed on Jul. 18, 2001.

(51) Int. Cl. H01Q 1/12

(52) U.S. Cl. 343/878

(57) ABSTRACT

An adjustable support column for an architectural panel has a vertical column, an angular support and outriggers for attachment of panels. The support column is used as a component in an architectural disguise for radio antennae.

### RELATED APPLICATIONS

This application is a continuation-in-part of U.S. application Ser. No. 09/908,094 filed Jul. 18, 2001.

### FIELD OF THE INVENTION

This invention relates to an adjustable support column suitable for use as an universal mounting support in the fabrication of structures to disguise transmitting and receiving antennae and to improved methods for mounting panels to column supports.

### BACKGROUND IN PRIOR ART

The proliferation of wireless devices including, but not limited to digital television receivers and cellular telephone transmitters/receivers has greatly increased the number of antennae, particularly in populated areas. To many people living in those areas, these functional devices are considered to seriously detract from the aesthetic character of the surrounding area. This is a particular problem in so called “Historic Districts” in which people strive to maintain the outward appearance of the world before Marconi.

Numerous designs have been developed to integrate antennae into unobtrusive or existing structures. U.S. Pat. No. 4,710,778 to Radov incorporates a satellite dish with an adjustable mount into an inclined roof of a building with the dish covered by large bubble. U.S. Pat. No. 4,896,164 to Burke et al. discloses a radar/transparent window in the form of plastic sheets having the external appearance of a glass window. U.S. Pat. No. 5,349,362 to Forbes et al. discloses an antenna concealed within an apparently convention plumbing vent stack on the roof of a building. U.S. Pat. No. 5,533,304 to Noble discloses an adjustable antenna including multiple mounting points.

U.S. Pat. No. 5,625,369 to Newman discloses thin panel antennae which display graphic representations and colorations compatible with the surface of a building. U.S. Pat. No. 5,641,141 to Goodwin discloses an antenna assembly which may be mounted on an existing street light or other utility pole. U.S. Pat. No. 5,852,424 to Reineck et al. discloses antenna enclosures which are transparent to electromagnetic radiation but constructed to give the appearance of existing or adjacent architectures. U.S. Pat. No. 6,111,553 to Steenbuck discloses an adjustable antenna bracket for attaching antennae to existing wooden utility poles or to existing rooftops.

The devices described above suffer from at least one of the following deficiencies:

(a) They must be custom designed for each specific application; or

(b) The antenna has not been rendered invisible but merely less obtrusive.

### BRIEF DESCRIPTION OF THE INVENTION

It is the object of this invention to provide a standardized adjustable assembly column for the erection of electromagnetically transparent architectural panels used to disguise radio antennae and particularly cellular phone antennae. The objective is accomplished by providing a vertical support column having a base, an angular support having a base and attached to a vertical support column using an adjustable kicker plate and outriggers mounted to the vertical support column which are adjustable vertically on the column and also extensible horizontally. The use of bolts to attach the transparent architectural panels to the columns may be minimized by the use of channelized mounting attachments so that a traditional architectural appearance can be achieved.

### BRIEF DESCRIPTION OF THE DRAWINGS

FIG. 1 is a side view of the adjustable column according to this invention.

FIG. 2 is a ¾ layer view of the support column.

FIG. 3 is a side view of the column with a wall section attached.

FIG. 4 shows a portion of a wall constructed according to the invention.

FIG. 5 is an isometric view of a mounted panel showing the location of the improved attachment device.

FIG. 6 is a detailed side view of an “F” channel.

FIG. 7 is a side view of a “J” girt channel for the base of a panel.

FIG. 8 is a detail of an F-channel.

FIG. 9 is a detail of a “J” girt channel.

### DETAILED DESCRIPTION OF THE INVENTION

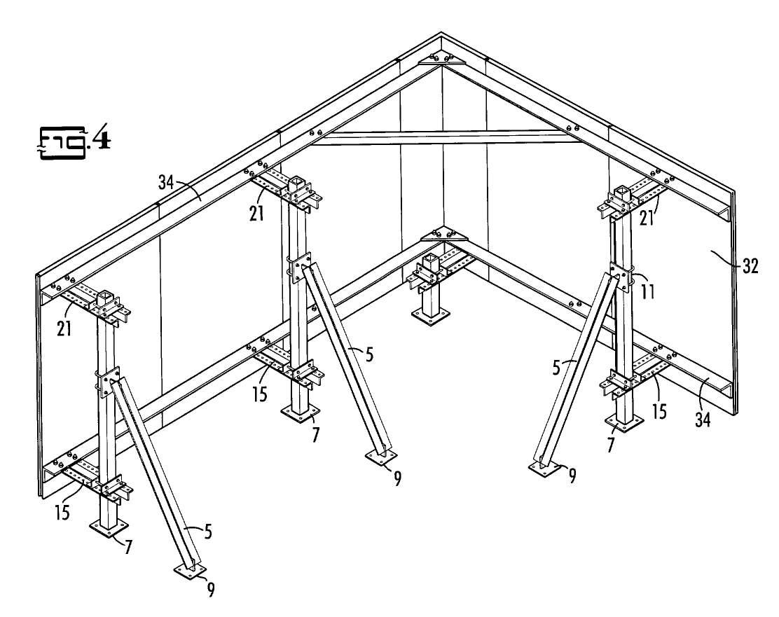

Reineck et al., U.S. Pat. No. 5, 852,424 discloses building elements for the construction of enclosures which blend antenna mountings into the overall appearance of a building to effect a disguise. As is evidenced from the disclosure from the Reineck et al. patent, and with particular reference to FIGS. 5 and 6 thereof, the supports disclosed must be prepared in an offsite fabrication shop or assembled in the field which involves a custom fabrication operation at the job site. The cost of installation and attendant delays are greatly mitigated when the components are standardized in overall dimension and the mounting brackets adjustable to conform to any surface. This is particularly true in situations where the roof of a building has been tapered in some way to facilitate drainage. Flat roofs on old buildings are rarely flat.

According to the invention, the adjustable assembly of this invention consists of a vertical support column having a base, an angular support articulated from an kicker plate mounted on the vertical support and one or more outriggers adjustably mounted on the vertical support.

As shown in FIG. 1, the adjustable column assembly 1 consists of the vertical column 3 having a base 7. Supporting the vertical column 3 is angular support 5 having an articulated base 9 for mounting onto a surface, which may or may not be the same surface for mounting point base plate 7 and attached to the vertical column at kicker plate 11. Kicker plate 11 is mounted in an adjustable manner so as to be raised or lowered on column 3 and the connection between angular support 5 and the kicker plate allows for the adjustment of the angle between the vertical support and the angular support over a wide range. This adjustment is needed to compensate for changes in the height of the mounting surface(s) and also for those situations when support must be obtained from a vertical architectural element.

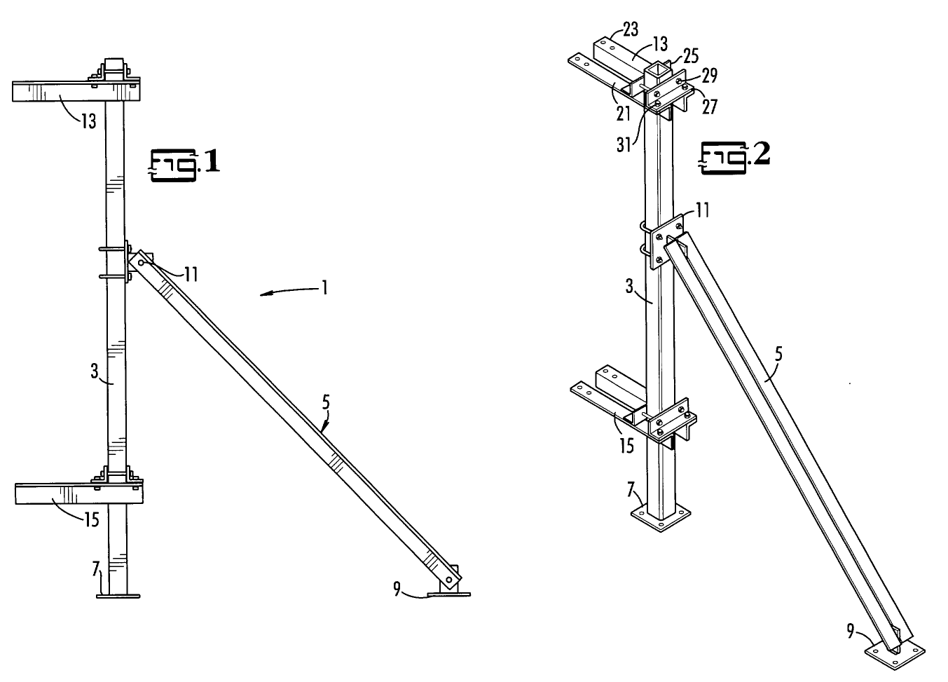

The vertical support is used to locate outriggers. As shown in FIGS. 1 and 2, there is a first or upper outrigger 13 and a second or lower outrigger 15. In certain circumstances additional outriggers may be required which may or may not be parallel to the first outriggers.

As shown in FIG. 1 and 2 the vertical support column may be round pipe or tubing, “I” beam, angle section, channel section or square tubing. Square tubing or “I” beams are preferred. The local support column is mounted on a base plate 7. Base plate 7 may be integral with (i.e. welded to) support column 3. Alternatively, a separate foot may be used and the column 3 inserted into or slid over the foot and appropriately secured. A separate foot is required when the vertical support is mounted on a support which is not horizontal. Conventional fastening means including threads, bolts, rivets and pins may be used. Conventionally the foot plate would be bolted to the support structure although any suitable mounting means including screws, screw anchors or U-clamps could be applied.

Angular support 5 may be any of the structural shapes discussed with respect to vertical support column 3. Because it is desired to have an adjustable angle at the foot 9 and the kicker plate 11, angle (double) section is preferred. Foot 9 is conventionally a flat plate with a raised ear. The plate may be attached to a surface using suitable means as discussed above. A through bolt traversing both angles and passing through the ear is a preferred method of attachment. Likewise, at the end attached to the vertical support, the kicker plate includes an ear through which a bolt may be passed. Depending upon the severity of the angles the angle brace may face upward (as shown in FIG. 2) or downward.

Kicker plate 11 is, in the preferred embodiment, a flat plate with a raised ear. The plate is adjustably attached to vertical support column 3 using U-bolts, preferably square U-bolts.

Outrigger 13 consists of a pair of projecting arms 21, 23 for attachment to the external architectural components such as building elements disclosed in U.S. Pat. No. 5,852,424 to Reineck et al.. Typically, they are steel or FRP angle section. The arms are bolted to a forward brace and a rear brace using suitable vertical fasteners 31. The outriggers are secured to upright 3 using horizontal fasteners 29. By tightening or loosening horizontal fasteners 31, the outrigger may be adjusted vertically on support column 3.

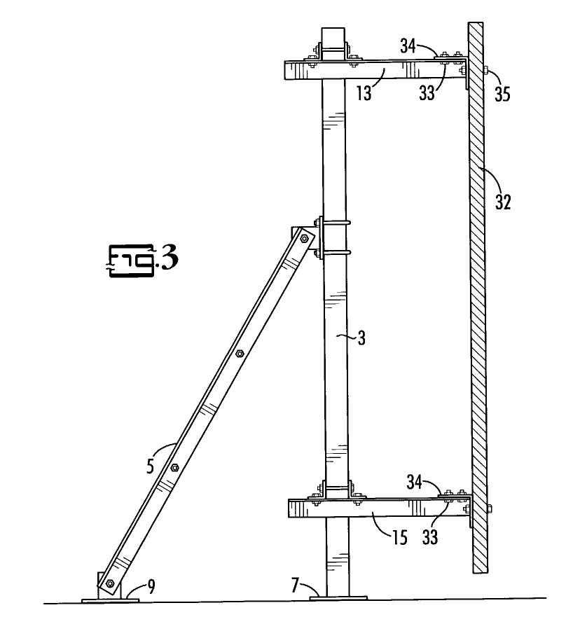

FIGS. 3 and 4 show how the support is used to mount a section of wall. A continuous horizontal support called a girt 34 is bolted to outrigger arms 13, 15 using bolts 33. The girt is bolted to the wall section by a series of evenly spaced bolts 35 at intervals along the wall sections. The girts 34 at top and bottom are essentially the same in this embodiment. FIG. 4 shows how multiple sections of support and wall sections form an exterior wall. By using standard sizes, the architectural disguises can be fabricated very quickly and in a wide variety of configurations. Wall 32 is formed from multiple panels of radio frequency (RF) transparent sections. Acrylonitrile-butadiene-styrene (ABS) copolymer is the preferred skin material and is typically formed in sheets which are laminated to a polystyrene foam core. The total thickness, selected in consideration of the radio frequencies transmitted through the panel, are typically between 1½ and 3½ inches. For cellular communication antenna, 2 3/16 inch panels are preferred. The panels are easily drilled and bolted to the outrigger arm. The multiple bolts 35 are not easily hidden and look anomalous in some settings.

We have developed an improved mounting system which is less visible than the aforementioned one. The improved mounting system shown in FIG. 5 consists of an “F” channel 41 which is adhered to the top of wall 32 and a “J” girt 43 which supports the base. The “F” channel 41 is preferably used to support the top of the wall section as shown in FIG. 6 although it may be used as a bottom support in a reverse orientation..

The “F” channel 41, shown separately in FIG. 8, which may be a PVC extrusion, has a backing channel wall 49 and a front overlay 51. Wall panel 32 is inserted between wall 49 and overlay 51 and attached with an adhesive. Suitable adhesives are urethane and other chemical bonding agents which are solvent-based. The “F” channel is preferably used in conjunction with a girt 134 which may be physically the same as girt 34 but does not receive bolts from the front (i.e., through the wall section). The method of attachment is shown in FIG. 6. A girt 134 and the “F” channel 41 are laid over arms 13 and fastened using bolts 33. Additional bolts may be used to connect the “F” channel to girt 134 so that the heavier FRP girt supports the “F” channel. Bolt holes 45 as shown in FIG. 8 are generic indicia of fastening locations at the top surface of “F” channel 41. In some uses, when smaller panels are employed and support of a girt 134 is not required, the “F” channel may be bolted directly to the outrigger arm. When thermosetting adhesives are used, the “F” channel is affixed to the panel before shipment

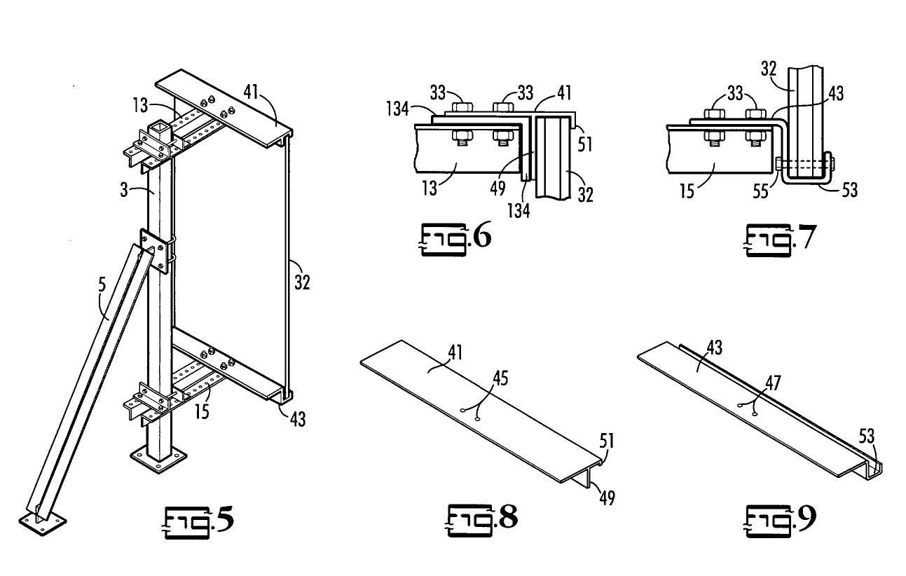

The bottom “J” girt 43 is typically used to support the wall section 32 at the bottom and is the primary load bearing member. The girt 43 bolts directly to lower outrigger arm 15 using bolts 33. The method of attachment is shown in FIG. 7 and the “J” girt is shown in FIG. 9.

The “J” girt has a channel 53 into which the panel 32 is inserted. In a first embodiment, the panel is bolted into the channel using through bolts 55. Alternatively, the “J” girt may be adhered to the panel in a manner similar to that used to mount the “F” channel. Bolt holes 47 are used for mounting to outrigger 15. The girt is preferably formed from FRP.

An important advantage of the “F” channel and “J” girt system described herein is ease of erection. The wall panels can be inserted into the girt, which then supports the weights while mounting is completed. No longer is it required to hold the panel in place while attaching to the support system and the installation becomes quicker and safer.

The invention has been illustrated and described in detail in the drawings and foregoing description. It is understood that only a preferred embodiment has been shown and described. All changes and modifications that come within the spirit of the invention as defined by the following claims a desire to be protected.

What is claimed:

1. In an adjustable support column for architectural panels consisting of a vertical support column having a base, an angular support having a base, an adjustable kicker plate connecting said vertical support column and said angular support and at least one outrigger adjustably mounted onto said vertical support column, the improvement comprising supporting the architectural panel using a girt bracket having a channel into which the bottom of an architectural panel rests.

2. The improvement according to claim 1 wherein said girt bracket is formed from an engineering plastic.

3. In an adjustable support column for architectural panels consisting of a vertical support column having a base, an angular support having a base, an adjustable kicker plate connecting said vertical support column and said angular support and at least one outrigger adjustably mounted onto said vertical support column, the improvement comprising locating the top of the architectural panel using an “F” channel adhesively attached to said architectural panel.

4. In an adjustable support column for architectural panels consisting of a vertical support column having a base, an angular support having a base, an adjustable kicker plate connecting said vertical support column and said angular support, at least one outrigger adjustably mounted onto said vertical support column, the improvement comprising supporting the architectural panel using a girt bracket having a channel into which the bottom of the architectural panel rests and locating the top of the architectural panel using an “F” channel adhesively attached to said architectural panel.

5. The improvement according to claim 3 wherein the “F” channel is formed from an engineering plastic.

6. The improvement according to claim 4 wherein said grit bracket and said “F” channel are formed from engineering plastics.

7. The improvement according to claim 2 wherein said girt bracket is formed from a fiberglass reinforced engineering plastic.

8. The improvement according to claim 5 wherein said engineering plastic is an extruded PVC.
